(19) United States
(12) Patent Application Publication
(10) Pub. No.: US 2026/0220588 A1
(43) Pub. Date: Jul. 30, 2026

(54) APPROACHES TO DIGITALLY LABELING BULK HARVESTED MATERIALS WITH INFORMATION REGARDING ORIGIN TO PERMIT TRACKING OF THE SAME DURING GATHERING, HANDLING, AND DISTRIBUTING ACTIVITIES

(71) Applicant: CODA Farm Technologies, Inc., Seattle, WA (US)

(72) Inventors: Connor J. Wallace, Seattle, WA (US); David C. Wallace, Baltimore, MD (US)

(21) Appl. No.: 19/140,976

(22) PCT Filed: Dec. 21, 2023
(86) PCT No.: PCT/US2023/085533

§ 371 Date: Jun. 18, 2025

Related U.S. Application Data
(60) Provisional application No. 63/434,264, filed on Dec. 21, 2022.

(51) Int. Cl. G06Q 10/0833; H04W 4/38

(52) U.S. Cl. CPC G06Q 10/0833; H04W 4/38

(57) ABSTRACT

Introduced here is a harvest indexing system (or simply “system”) that employs a different approach to track produce with high precision throughout the entire “pipeline.” Said another way, the system may be designed to track produce throughout its existence, potentially beginning with planting and inclusive of the growing, harvesting, processing (e.g., washing and sorting), packaging, transporting, and even storing stages—collectively referred to as the “produce lifecycle.” The system may utilize embedded tracker mechanisms that can collect, convey, or store information about the produce lifecycle. These embedded tracker mechanisms can be designed to closely match the physical properties of produce so that the indices can more easily travel with the produce throughout the produce lifecycle undisturbed.

### CROSS-REFERENCE TO RELATED APPLICATIONS

This application is a 371 National Phase entry of PCT/US2023/085533 filed Dec. 21, 2023, which claims priority to U.S. Provisional Application No. 63/434,264, titled “Approaches to Digitally Labeling Bulk Harvested Produce or Materials with Origin Data and Tracking the Same” and filed on Dec. 21, 2022, which is incorporated by reference herein in its entirety.

### TECHNICAL FIELD

Various embodiments concern approaches to establishing, documenting, and then monitoring the location of harvested products through the use of embedded tracer mechanisms.

### BACKGROUND

The goal of produce traceability is to allow farmed produce (or simply “produce”) to be tracked from its point of origin to a retail location where it is purchased by consumers. Produce traceability is an important link in protecting public health because it allows agencies to more quickly and accurately identify the source of contaminated produce, for example, that is believed to be the cause of an outbreak of foodborne illness, remove the contaminated produce from the marketplace, and communicate with retailers and consumers that may be affected.

Some forms of produce—specifically fruits and vegetables—are commonly eaten raw, and therefore, farmers, distributors, and retailers work diligently to protect these forms of produce from contamination. Despite best efforts, foreign matter can contaminate produce in the field prior to harvesting or during the packing, processing, or transporting processes. Technologies-like controlled cold chains—have been developed in an effort to reduce opportunities for contamination; however, contamination is difficult, if not impossible, to fully prevent due to the large amounts of produce that are farmed and various conditions under which the produce is handled and then sold.

Conventionally, traceability systems have endeavored to provide information on the source, location, movement, or storage conditions of produce. Some of these conventional traceability systems allow farmers, packers, processors, distributors, and retailers to identify factors that affect quality and delivery, among other characteristics. Conventional traceability systems commonly rely on either radio-frequency identification integrated circuits (also called “RFID chips”) or machine-readable visual indicia, such as barcodes and quick response codes (also called “QR codes”).

RFID chips are commonly implemented in RFID “tags” that are applied directly to produce and used as track-and-trace solutions. RFID tags are representative of a code-carrying technology, and therefore can be used instead of a machine-readable indicium to enable reading without line of sight.

Widespread deployment of RFID tags has been inhibited by limitations, including cost, readability in practice, and concerns over privacy. Simply put, the cost of RFID tags limits the economic justification for “tagging” on a per-item level. While tagging at a broader level (e.g., per package, per truckload, etc.) is less costly, information is lost when fewer RFID tags are employed. For example, it is not uncommon for a single package to ultimately include produce harvested from different locations, on different dates, or by different famers. Orientation of the produce, packing density, and content-specifically water that is predominant in produce-can also have a significant detrimental effect on readability in practice.

Barcoding is a common approach to implementing traceability. For example, variable data can be encoded in a machine-readable format or human-readable format (e.g., a numeric code or alphanumeric code) that is applied to the package or label of produce. This variable data can be used as a “pointer” to traceability information. Barcoding is much more cost effective than RFID tags. Barcoding is not without its own issues, however. Readability of these visual indicia can be difficult in practice. Assume, for example, that variable data is printed on a sticker that is affixed to produce associated with the variable data.

The sticker may be dislodged if the produce is exposed to water, or the sticker may be dislodged due to jostling (e.g., against other produce, packaging, etc.). Widespread deployment can also be burdensome, as these visual indicia tend to be affixed to produce on a per-item basis.

### BRIEF DESCRIPTION OF THE DRAWINGS

FIG. 1 includes a high-level illustration of a system that can be configured to actively or passively monitor indices.

FIGS. 2A-C include images of an illustrative demonstration of the aforementioned approach to tracing produce through its lifecycle.

FIG. 3 illustrates a network environment that includes a management platform that is executed by a computing device.

FIG. 4 illustrates an example of a computing device able to implement a management platform designed to manage data generated for produce over the course of its lifespan.

FIG. 5 is a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the present disclosure. Accordingly, although specific embodiments are shown in the drawings, the technology is amenable to various modifications.

### DETAILED DESCRIPTION

Adoption of conventional systems for tracing produce has been slow. Conventional traceability systems that rely on RFID tags tend to be expensive to implement in a widescale manner, while conventional traceability systems that rely on visual indicia tend to be burdensome to implement in a widescale manner. Moreover, both types of conventional traceability systems can struggle with readability in practice.

Another factor that complicates tracing is that the harvesting, packing, processing, and transporting processes are generally muddled. Traditional processes tend to mix produce together at different stages of the “pipeline” as produce travels from its origin to its destination—or “from field to fridge.” As an example, consider the traditional process by which potatoes are harvested.

Potatoes are normally dug up across a large area (e.g., one or more fields spanning multiple acres) at one time, and after harvesting, the potatoes are normally mixed together in trucks while being taken away for processing. A given truck might contain potatoes from various locations in a single field or even multiple fields.

When produce is harvested, information regarding origin is commonly lost due to batching in larger and larger bins. Combined with a lack of recordkeeping, this makes it difficult, if not impossible, to know where produce originated with specificity. When harvesting blueberries or raspberries, for example, a picker may walk down rows in succession, picking berries and depositing the berries into a bucket. The bucket is filled with berries that are known to be picked within the bounds of a swath of a field. However, it would be impractical for the picker to maintain records of where the berries were picked.

Multiple buckets are berries are normally mixed in flats. These flats are then loaded into pallets, which tend to be mixed together based on demand.

Accordingly, many fields'worth of berries (and sometimes, many farms'worth of berries) may be mixed together before being packaged and transported. Further complicating the traceability issue, entities commonly rely on paper records that indicate the origin of produce. For example, farmers or processors may maintain paper records that specify the field(s) from which a pallet of berries were harvested. This requires diligence on the part of these entities to maintain accurate paper records—a difficult task if large amounts of produce are being harvested or processed.

Not knowing where produce originates can result in several large problems for farmers. Notably, instances of contamination must generally be addressed through large recalls, as smaller, more targeted recalls are simply not possible given the lack of insight into the path of the contaminated produce through the “pipeline” mentioned above. If it turns out that some produce is contaminated, retailers have historically needed to recall all produce that could be associated with (e.g., come into contact with) the crop. Knowing little about where the contaminated produce was harvested, processed, and packaged not only makes it tougher to address the problem, but also understand why the problem happened in the first place.

It is practically impossible for a farmer to know with any precision whether decisions—for example in terms of which seeds to use, which pesticides or fertilizers to apply, how much water to apply, how many individuals to hire to assist with harvesting—are influencing the quality and value of her produce. These decisions can cost significant money, and the stakes are high as a small increase in quality or consistency can result in a much larger sale price. Similarly, a small decrease in quality or consistency can result in a much smaller sale price.

Introduced here is a harvest indexing system (or simply “system”) that employs a different approach to track produce with high precision throughout the entire “pipeline.” Said another way, the system may be designed to track produce throughout its existence, potentially beginning with planting and inclusive of the growing, harvesting, processing (e.g., washing and sorting), packaging, transporting, and even storing stages—collectively referred to as the “produce lifecycle.”

As further discussed below, the system may utilize embedded tracker mechanisms (also called “trackers” or “indices”) that can collect, convey, or store information about the produce lifecycle. Indices can be designed to closely match the physical properties (e.g., in terms of size, shape, color, density, weight, buoyancy, etc.) of produce so that the indices can more easily travel with the produce throughout the produce lifecycle undisturbed. Consider, for example, a scenario in which greater insight into a given produce (also called a “target produce”) is desired. An index that is representative of a tracing mechanism can be designed to travel with the target produce, so that the index can be embedded in a batch of the target produce or in a stream of the target produce. Accordingly, an index designed to be embedded with blueberries may differ in terms of size, shape, color, density, weight, or buoyancy from an index designed to be embedded with potatoes or an index designed to be embedded with strawberries.

Note that, in some embodiments, an index may be designed and constructed to generally correspond to the produce with which it is to be embedded, except for one or more characteristics. Assume, for example, that an index is to be embedded with potatoes. The index may have a similar size, shape, and weight as the potatoes but may be a different color, so as to be readily distinguished from—and therefore more easily separated from—the potatoes. Such an index may be useful if the potatoes are to be visually examined, for example, by a pick-and-place machine that applies, to digital images of the potatoes, a machine learnt model developed for computer vision to determine which potatoes should be removed. As another example, the index may have a similar size, shape, and color as the potatoes but may be a different weight and/or buoyancy. Such an index may be useful if the potatoes are to be sorted by weight, as the index can be separated from the potatoes as a normal part of that sorting process.

Because indices are designed to emulate the produce with which those indices are embedded, such an approach to tracing has minimal impact on the produce lifecycle. In fact, an index may travel with produce without disruption of the spatio-temporal location of the index with respect to the produce to which it is in close proximity and, by association, the location at which the produce was grown and harvested.

Information can be written to, or read from, indices at any point in the produce lifecycle. For example, information regarding location may be input by a farmer before or during the harvesting process, before that index is embedded with produce harvested as part of the harvesting process. Ultimately, the information contained within each index can be read or extracted. For example, the information contained within a given index could be read immediately prior to packaging for shipment to retailers, recorded to a database, and associated with a product label to be printed on the packaging for any produce in close proximity to the given index. Additionally or alternatively, the information within indices could be recorded in external sorting systems and/or external yield-tracking systems for correlation with data collected external to the system.

Indices can be cheaply designed and manufactured, allowing users of the system to achieve high precision for a large spatiotemporal range without making a prohibitively large investment. Moreover, because indices can be cheaply designed and manufactured, loss of individual indices may not be a substantial concern. Simply put, the indices may be sufficiently inexpensive that multiple indices can be embedded in a single batch of produce, lessening the likelihood that insights into location are lost due to loss of an entire index (e.g., due to destruction or misplacement) or loss of data (e.g., due to damage to an internal component of an index, such as a processor or sensor).

There are several applications and benefits of the aforementioned approach to tracking location, including:
A farmer can use the system to view geospatially precise yield information about produce in a way that has not historically been possible. For example, a farmer may be able to view the variation in a wide variety of yield aspects (e.g., size distribution, color, shape, defects) within a field in order to better understand how variation in inputs (e.g., fertilizers, pesticides, water from irrigation or precipitation, temperature, soil makeup, soil texture, effort in terms of weeding, trimming, etc.) correlate with those yield aspects. This understanding can be used to build improved farming plans that can boost yield or control an aspect of the yield, such as quality or growth rate.
   Relatedly, machine learning (“ML”) algorithms could be trained on inputs and/or yield data to build detailed, targeted recommendations for various inputs.
A consumer can use the system to learn information such as where produce was grown, how long ago produce was harvested, what inputs were used by the farmer, and the like.
Public health officials can use the system to trace contaminations (e.g., corresponding to discovered pathogens) back to the origin with unprecedented precision.
Experts—like agronomists and chemists—can use the system to design and execute field trials for new products (e.g., seeds, fertilizers, pesticides) and approaches to farming without the need for exhaustive design or manual data collection.
Harvesters of wild products (e.g., fish, shellfish, mushrooms) can use the system to collect or maintain detailed records that demonstrate freshness. These records could be used in the planning of future harvests, as insights (e.g., into yield) can be gleaned through manual or automated analysis of these records. Moreover, with these records, harvesters may be able to demonstrate compliance with laws that govern protected wild products, such as certain species of wild fish and conflict materials.

Accordingly, information generated by, or stored on, indices can be used to create, update, or support an auditable log of information.

### Terminology

References to “an embodiment” or “some embodiments” means that the feature being described is included in at least one embodiment. Occurrences of such phrases do not necessarily refer to the same embodiment, nor do they necessarily refer to alternative embodiments that are mutually exclusive of one another.

The term “based on” is to be construed in an inclusive sense rather than an exclusive sense. That is, in the sense of “including but not limited to.” Accordingly, the term “based on” is intended to mean “based at least in part on” unless otherwise noted.

The terms “connected,” “coupled,” and variants thereof are intended to include any connection or coupling between two or more elements, either direct or indirect. The connection or coupling can be physical, logical, or a combination thereof. For example, elements may be electrically or communicatively connected to one another despite not sharing a physical connection.

When used in reference to a list of items, the word “or” is intended to cover all of the following interpretations: any of the items in the list, all of the items in the list, and any combination of items in the list.

### Overview of Harvest Indexing System

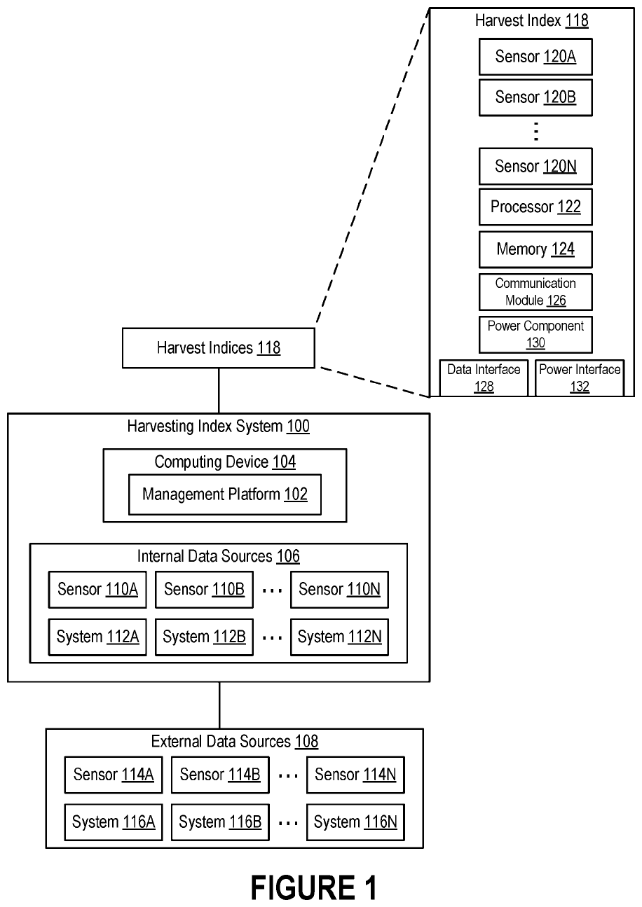

FIG. 1 includes a high-level illustration of a system 100 that can be configured to actively or passively monitor indices. As further discussed below, the system 100 can include a data management platform 102 (or simply “management platform”) that is executed by a computing device 104. Through the management platform 102, a user may be able to manage the system 100 or view data collected by the system 100.

In embodiments where the system 100 is a “passive indexing” system, the system 100 may be connected to one or more data sources 108 that are external to the system 100. These external data sources 108 may be associated with different stages of the produce lifecycle, such that information about produce can be gleaned throughout its journey. These external data sources 108 can include external sensors 114A-N, external systems 116A-N, or a combination thereof. Examples of external sensors 114A-N include image sensors, weight sensors, temperature sensors, humidity sensors, and the like. Meanwhile, examples of external systems 116A-N include network-accessible storage as well as harvester machines (e.g., combine harvesters, solid set harvesters, etc.), coating machines (e.g., for spraying produce), fertilizer spreaders (e.g., broadcast spreaders, manure spreaders, slurry spreaders, etc.), seeding machines (e.g., broadcast seeders, air seeders, etc.), irrigation systems, sorting systems (e.g., roller graders, pick-and-place machines, etc.), and the like. From these external data sources 108, the system 100 may obtain data related to various characteristics of the produce lifecycle or the produce itself. For example, these data may be related to yield aspects (e.g., size distribution, color, shape, firmness, weight, defects) of the produce, inputs (e.g., fertilizers, pesticides, water from irrigation or precipitation) during the growing stage, characteristics (e.g., temperature, soil makeup, soil texture, days since planting) of the growing stage, characteristics (e.g., temperature, humidity, packaging type, packing density, days since harvesting) of the processing and packaging stages, characteristics (e.g., temperature, humidity, duration, days since harvesting or packing) of the transporting and storing stages, and the like. To connect a given external data source with the system 100, a user may be prompted to complete an onboarding process via an interface that is generated by the management platform 102. For example, through the interface, the user may specify a software interface (e.g., an application programming interface) that is associated with the given external data source, and from which data can be obtained from the given external data source.

In embodiments where the system 100 is an “active indexing” system, the system 100 may include one or more data sources 106 that are internal to the system 100. These internal data sources 106 can be comparable to the external data sources 108, except that the system 100 may be responsible for managing these internal data sources 106. Accordingly, these internal data sources 106 may be associated with different stages of the produce lifecycle, such that information about produce can be gleaned throughout its journey. These internal data sources 106 can include internal sensors 110A-N, internal systems 112A-N, or a combination thereof. From these internal data sources 106, the system 100 may obtain data related to various characteristics of the produce lifecycle or the produce itself. For example, these data may be related to yield aspects (e.g., size distribution, color, shape, firmness, weight, defects) of the produce, inputs (e.g., fertilizers, pesticides, water from irrigation or precipitation) during the growing stage, characteristics (e.g., temperature, soil makeup, soil texture, days since planting) of the growing stage, characteristics (e.g., temperature, humidity, packaging type, packing density, days since harvesting) of the processing and packaging stages, characteristics (e.g., temperature, humidity, duration, days since harvesting or packaging) of the transporting and storing stages, and the like.

Regardless of whether the system 100 is configured for passive or active indexing, data generated by the sources 106, 108 could be programmatically associated with, or stored on, indices. Assume, for example, that indices are intermixed with potatoes in containers during the harvesting stage. Further, assume that yield aspects are monitored by a plurality of sensors during the harvesting stage or shortly thereafter (e.g., during the processing stage). In response to discovering a given index, data generated by the plurality of sensors could be programmatically associated with the given index (e.g., by appending metadata that identifies the given index thereto) and then the data could be transmitted to the system 100. Additionally or alternatively, the data could be transmitted to the given index for storage in local memory. This “local storage” approach may be useful for locations or stages where network connectivity is likely to be inconsistent. Note that indices that are able to receive and store data may also have the necessary components (e.g., a communication module) for subsequently offloading the data to the system 100.

Like the system 100, the indices 118 intermixed with produce could also be passive or active. The different implementations of the system 100 enable the collection and storage of different data throughout the produce lifecycle, albeit in different ways. “Passive indices” may not be able to collect information on their own but instead store and process data that is collected by the external data sources 108 (e.g., external sensors 114A-N or external systems 116A-N) for subsequent retrieval or analysis by the management platform 102. “Active indices,” meanwhile, can collect information about produce in situ. For example, an “active indexing” system could include sensors 120A-N that are able to collect and store data throughout the produce lifecycle. Each of the sensors 120A-N may be responsible for detecting, measuring, or documenting a physical property that affects the index 118 (and therefore, can be assumed to affect the produce with which the index 118 is embedded), Examples of physical properties include soil moisture, soil chemical composition, temperature, humidity, light exposure, acceleration, orientation, and the like. In addition to the sensors 120A-N, active indices may also include a processor 122 for processing data generated by the sensors 120A-N, memory 124 for storing the processed data, or a communication module 126. In some embodiments, the data generated by the sensors 120A-N is stored in its “raw form,” and therefore little or no processing may be performed on the index.

The processor 122 can have generic characteristics similar to general-purpose processors, or the processor 122 may be an application-specific integrated circuit (“ASIC”) that provides control functions to the index 118.

The memory 124 may be comprised of any suitable type of storage medium, such as static random-access memory (“SRAM”), dynamic random-access memory (“DRAM”), electrically erasable programmable read-only memory (“EEPROM”), flash memory, or registers. In addition to storing instructions that can be executed by the processor 122, the memory 124 can also store data generated by the processor 122 and produced, retrieved, or obtained by the other components of the index 118. For example, data received by the communication module 126 may be stored in the memory 124, and data generated by the sensors 120A-N may be stored in the memory 124. Note that the memory 124 is merely an abstract representation of a storage environment. The memory 204 could be comprised of actual memory integrated circuits (also referred to as “chips”).

The communication module 126 may be responsible for managing communications between the components of the index 118, or the communication module 126 may be responsible for managing communications with other computing devices (e.g., computing device 104, internal data sources 106, or external data sources 108). The communication module 126 may be wireless communication circuitry (e.g., a wireless transceiver) that is designed to establish communication channels with other computing devices. The communication module 126 may communicate with other computing devices via a bidirectional communication protocol, such as Near Field Communication (“NFC”), wireless Universal Serial Bus (“USB”), Bluetooth®, Wi-Fi®, a cellular data protocol (e.g., LTE, 3G, 4G, or 5G), or a proprietary point-to-point protocol.

Accordingly, it may be possible to offload data from the indices 118 in several ways. In some embodiments, each index 118 includes a communication module 126 that permits data to be wirelessly retrieved therefrom, as discussed above. Additionally or alternatively, each index 118 could include a physical port—also called a “data interface” 128—that permits data to be retrieved therefrom using a cable. The physical port could be a USB Type-C (“USB-C”) connector, for example.

The index 118 may include a power component 130 that is able to provide power to the other components, as necessary. Examples of power components include rechargeable lithium-ion (“Li-Ion”) batteries, rechargeable nickel-metal hydride (“NiMH”) batteries, rechargeable nickel-cadmium (“NiCad”) batteries, and the like. To recharge the power component 130, a cable designed to facilitate the transmission of power (e.g., via a physical connection of electrical contacts) may be connected between a power interface 132 of the index 118 and an external power source. Alternatively, the index 118 may include a power receiver that has a chip able to wirelessly receive power from an external power source. The power receiver may be configured to receive power transmitted in accordance with the Qi standard developed by the Wireless Power Consortium or some other wireless power standard.

Indices-both passive and active-can be reusable. Collection after a produce lifecycle can be performed so that the indices 118 can be used in subsequent cycles, for example, after data in the memory 124 is deleted.

The time at which the indices 118 are embedded with produce can vary based on the data to be collected, either by their own sensors 120A-N or external data sources 108. For example, indices could be embedded during the harvesting stage in order to track the spatiotemporal point of harvest through the processing, sorting, packing, transporting, and storing stages. As another example, indices could be embedded at planting time in order to track the spatiotemporal point of planting and obtain information about the growth process -in addition to the information regarding the harvesting, processing, sorting, packing, transporting, and storing stages.

The spatiotemporal density of indices embedded in produce throughout the produce lifecycle can impact the precision and statistical uncertainty of information obtained regarding the resulting yield, and therefore the traceability. As the density increases (e.g., by employing more indices), the precision also increases and the uncertainty in the association between a given piece of produce and a given index decreases. Users of the system 100 may be responsible for deciding on the desired level of precision and uncertainty based on intended application, cost constraints, and the like. Because indices are designed to roughly match the physical properties of the target product, increasing the number of indices may require harvesting, processing, sorting, packaging, transporting, or storing larger volumes and masses. These larger volumes and masses may become untenable at some point. Therefore, for a given type of produce, there may be an optimal spatiotemporal index density range that a user can choose from based on her requirements.

As mentioned above, the physical properties of an index can be varied to roughly match the physical properties of the target produce being tracked. Examples of physical properties include shape, size, color, density, weight, surface texture, buoyancy, and magnetic attraction. Note that the term “roughly match” may mean that the index matches the physical properties of the target produce within a threshold (e.g., within 5 percent, 10 percent, or 20 percent of average values) so that processes throughout the produce lifecycle do not need to be redesigned or reconfigured due to indices being embedded in the target produce.

The index may also be designed such that its ability to travel with batches or streams of the target bulk product is achieved through some form of physical attachment mechanism. For example, an index designed to be embedded with a textile harvest such as hemp could have a sticky or barbed surface that lends itself to attachment with the hemp fibers.

In some embodiments, the index is designed so as to be easily identifiable and recoverable. For example, an index may be shaped roughly similar to a potato for easier embedding throughout the produce lifecycle. However, visual properties of the index could be varied to aid in identification and recovery. Examples of visual properties include color, pattern, graphics (e.g., labels, logos, machine-readable identifiers, human-readable identifiers), fluorescence, phosphorescence, and the like. Additionally or alternatively, non-visual properties of the index could be varied to aid in identification and recovery. Examples of non-visual properties include weight, buoyancy, radioactivity, magnetism, and the like.

The mechanism by which data can be written to, and read from, the indices 118 can change depending on the intended implementation. For example, reading and writing could be performed by mobile computing devices—like tablet computers, mobile phones, and wearable devices—for produce that is normally harvested by hand, such as apples, oranges, and berries. As another example, reading and writing could be performed by less mobile computing devices-like laptop computers and desktop computers—for produce that is normally harvested by, or in conjunction with, a vehicle. These less mobile computing devices could be mounted on, or contained in, vehicles such as tractors, trucks, boats, planes, or drones.

The mechanism by which indices 118 are distributed can also change depending on the intended implementation. For example, indices 118 can be distributed by an automated hopper that automatically writes data to the indices 118 and distributes the indices 118 in accordance with a specified spatiotemporal pattern or density. As another example, indices 118 can be manually distributed by hand, for example, during the planting process, harvesting process, or packaging process. As another example, indices 118 could be “seeded,” for example, shortly after planting is complete or shortly before harvesting begins, with a plane or drone.

The mechanism by which indices 118 are recovered can also change depending on the intended implementation. For example, indices 118 can be manually recovered by hand as part of the sorting process or packaging process. As another example, indices 118 can be automatically recovered by an automated sorting mechanism that is responsible for sorting the produce in which the indices 118 are embedded. As another example, indices 118 can be automatically recovered by an automated recovering mechanism that is responsible for recovering the indices 118. The automated recovering mechanism may not have any responsibilities during the produce lifecycle other than recovering the indices 118. In some embodiments, the indices 118 may not be recovered at all. For example, the indices 118 may travel with the produce to consumers, who can then discard, return, or recycle the indices 118.

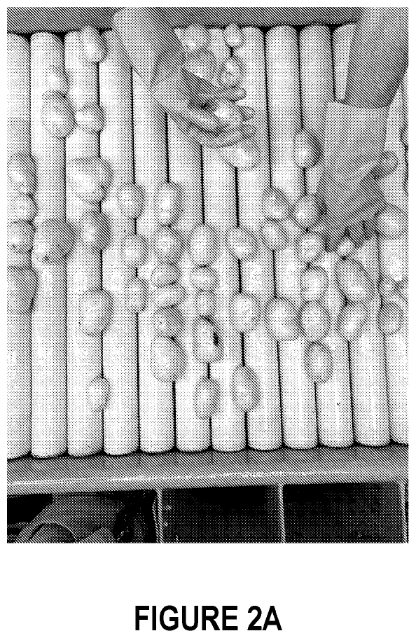

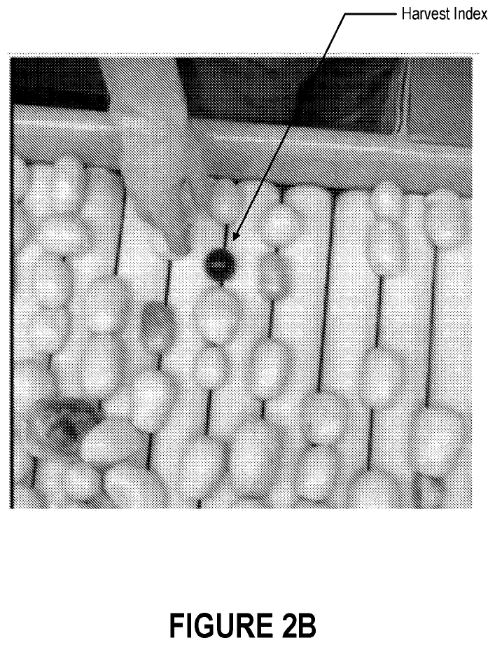

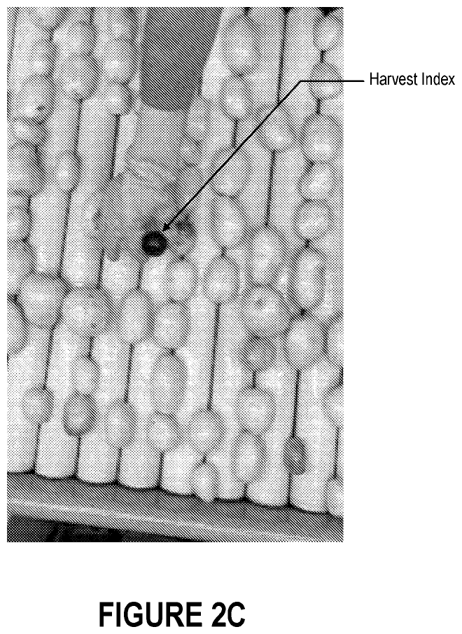

FIGS. 2A-C include images of an illustrative demonstration of the aforementioned approach to tracing produce through its lifecycle. The demonstration of the system involved placing indices in and among produce namely, potatoes-as the produce was grown and harvested. Because its size is roughly comparable to smaller potatoes, a golf ball had a radio frequency identification (“RFID”) tag with reading and writing capabilities secured thereto.

The RFID tag had a unique identifier and some data stored thereon, defining an “index.” This unique identifier was programmatically associated, in a data structure, with a precise geographic location of embedding and a timestamp indicative of the time at which embedded occurred. These data were written to the RFID tag by a computing device, and these data were stored in a network-accessible database by the computing device. Accordingly, the precise time and location at which the index was embedded were stored. A comparable process was performed during harvesting, so that the precise time and location at which the index was harvested were also stored.

These “indices” that are representative of RFID-tagged golf balls stayed with the produce after harvesting. Because these indices closely match the physical properties of the surrounding potatoes, these indices were able to travel in contact with the potatoes throughout the processing, sorting, packaging, transporting, and storing stages. FIGS. 2A-C, for example, show how an index can come through to the grading table because its physical properties are physical to the potatoes in which the index was embedded, but then can be easily separated from the potatoes because at least one physical characteristic (here, color) is different. Specifically, FIG. 2A illustrates how potatoes come through to the grading table, generally after a washing process, for visual inspection and separation. FIG. 2B illustrates how the index may accompany the potatoes to the grading table, while FIG. 2C illustrates how the index can be readily separated from the potatoes—either by hand or machine. Upon being separated from the potatoes, the index could be scanned, logged, or otherwise documented. For example, if the index includes an RFID tag, then the index may be exposed to an RFID sensor. Data generated by the RFID sensor upon detecting the RFID tag may be transmitted to the index for storage or stored in a memory external to the index.

Generally, the indices are intentionally designed to be distinct from the potatoes in at least one dimension—in FIGS. 2A-C, visually in terms of color—so that the indices can be easily identified by a human or computing device. In the demonstration, a computing device with a high-resolution camera and RFID sensor was situated near the sorting table. Each time that an index was detected, the computing device captured at least one high-resolution image of the surrounding pieces of produce, such that each piece could be characterized in terms of size, shape, quality, etc. The indices were then removed from the stream of produce immediately before the potatoes were packaged. The data included in the indices was recorded in the network-accessible database, and the unique identifier of each index was used to generate a unique label (e.g., with a QR code) that was printed on the packaging for the produce determined to be in close proximity to that index. Because each index had location information “baked” into it, that location information can be directly or indirectly associated with nearby produce.

While the index shown in FIGS. 2A-C is visually distinguishable from the potatoes, those skilled in the art will recognize that an index may be different than the produce with which it is embedded in a non-visual dimension. For example, the index may be lighter or heavier than the produce, so that it is naturally sorted out during a sorting process. As another example, the index may have a different buoyancy than the produce, so that it is naturally sorted out during a washing process. As another example, the index may be magnetic, so that it can be removed—during a sorting process, washing process, or packing process—by passing a magnet over the produce with which it is embedded.

Accordingly, to track produce through the harvesting, packing, processing, or transporting processes, one or more indices may be intermixed with the produce in a predetermined manner, such that each index is associated with a subset of the produce. These subsets may correspond to different farms, fields, or portions of fields, with the goal of providing more granular insight into the conditions experienced by the produce. As mentioned above, this could be done at various points during the lifecycle. Indices could be “planted” with seeds at the growing stage, or indices could be mixed with produce during the harvesting stage.

Then, each index may be documented at different stages of the lifecycle, so as to provide greater insight into the produce over the course of its lifecycle. By documenting the indices over time, an auditable log of conditions experienced by the different subsets of the produce can be created. With the indices, the produce can be more readily tracked, even as separation (e.g., produce from the same field is divided up) and combination (e.g., produce from different fields are combined) occur. Some embodiments of the indices may include one or more sensors as discussed above, and therefore may generate data while intermixed with the produce. This data may be retrieved on a periodic basis (e.g., when the indices are documented), or this data may be retrieved when the indices are finally removed from the produce (e.g., before distribution to retailers). Generally, the indices are removed-by hand or machine-before the produce is distributed to retailers for sale.

### Overview of Data Management Platform

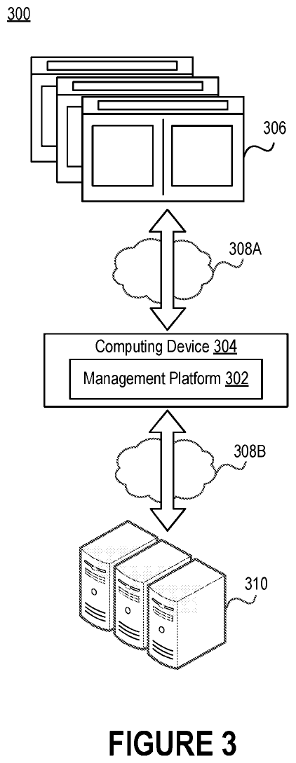

FIG. 3 illustrates a network environment 300 that includes a management platform 302 that is executed by a computing device 304. An individual (also called a “user”) may be able to interact with the management platform 302 via interfaces 306. Examples of users include farmers, consumers, public health officials, and experts (e.g., agronomists and chemists) that may access the interfaces 306 to view geospatially precise information about produce. These users may use the management platform 302 for different reasons. For example, a farmer may be interested in gleaning insights to implement to improve yields through analysis of the geospatially precise information, while public health officials may be interested in gleaning insights into relationships between yields to identify or limit contamination through analysis of the geospatially precise information. Different interfaces may be designed to be accessible to, or tailored for, these different types of users.

As shown in FIG. 3, the management platform 302 may reside in a network environment 300. Thus, the computing device 304 on which the management platform 302 resides may be connected to one or more networks 308A-B. Depending on its nature, the computing device 304 could be connected to a personal area network (“PAN”), local area network (“LAN”), wide area network (“WAN”), metropolitan area network (“MAN”), or cellular network. For example, if the computing device 304 is a computer server, then the computing device 304 may be accessible to users via respective computing devices that are connected to the Internet via LANs. As another example, if the computing device 304 is a mobile phone, then the computing device 304 may be accessible to a server system 310 via a cellular network.

The interfaces 306 may be accessible via a web browser, desktop application, mobile application, or another form of computer program. For example, to interact with the management platform 302, a user may initiate a web browser on the computing device 304 and then navigate to a web address associated with the management platform 302. As another example, a user may access, via a desktop application, interfaces that are generated by the management platform 302 through which she can observe data obtained by the management platform 302 or analyses of the data by the management platform 302. Accordingly, interfaces generated by the management platform 302 may be accessible to various computing devices, including mobile phones, tablet computers, laptop computers, desktop computers, and the like.

Generally, the management platform 302 is executed by a cloud computing service operated by, for example, Amazon Web Services®, Google Cloud Platform™, or Microsoft Azure®. Thus, the computing device 304 may be representative of a computer server that is part of a server system 310. Often, the server system 310 is comprised of multiple computer servers. These computer servers can include different types of data (e.g., information regarding farmers, processors, transporters, retailers, and indices) and algorithms for processing, presenting, and analyzing data generated by sensors, whether those sensors are included in indices (e.g., sensors 120A-N of FIG. 1), internal to a system (e.g., sensors 110A-N of FIG. 1), or external to a system (e.g., sensors 114A-N of FIG. 1). Those skilled in the art will recognize that this data could also be distributed among the server system 310 and one or more computing devices. For example, sensitive data generated by sensors may be stored on, and initially processed by, a computing device that is associated with a corresponding entity (e.g., a farmer, processor, or transporter), such that the sensitive data is filtered or obfuscated before being transmitted to the server system 310 for further processing. As a specific example, a farmer with a proprietary growing technique or a processor with a proprietary processing technique may want to keep information from which insights into those techniques could be gleaned on their own computing devices.

As mentioned above, aspects of the management platform 302 could be hosted locally, for example, in the form of a computer program executing on the computing device 304. Several different versions of computer programs may be available depending on the intended use. Assume, for example, that a user would like to actively guide the process by which information (e.g., regarding location) is associated with indices prior to deployment. In such a scenario, the computer program may allow the user to input or review the information, which may subsequently be stored in the indices and on the server system 310.

Alternatively, if a user is simply interested in reviewing data obtained by the management platform 302 or analyses of the data, the computer program may be “simpler.”

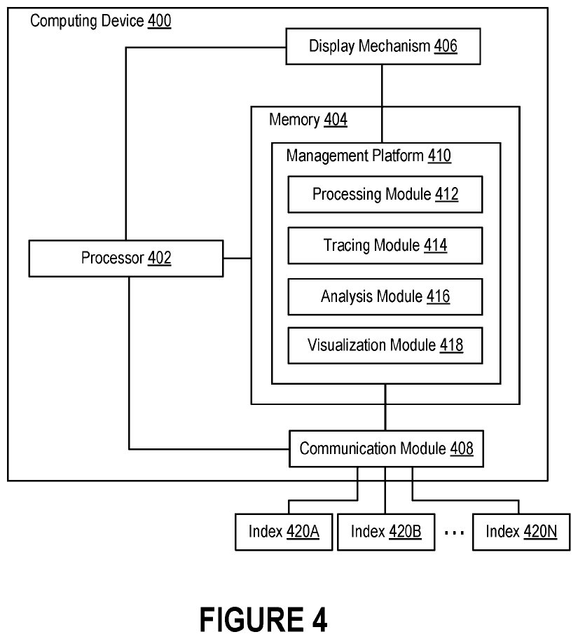

FIG. 4 illustrates an example of a computing device 400 able to implement a management platform 410 designed to manage data generated for produce over the course of its lifespan. As discussed above, the management platform 410 may utilize data generated by sensors included in indices 420A-N embedded in the produce, or the management platform 410 may utilize data generated by sensors external to the indices 420A-N. Data generated by sensors external to the indices 420A-N could be stored in the indices 420A-N or transmitted, either directly or indirectly, to the computing device 400. As shown in FIG. 4, the computing device 400 can include a processor 402, memory 404, display mechanism 406, and communication module 408. Each of these components is discussed in greater detail below.

Those skilled in the art will recognize that different combinations of these components may be present depending on the nature of the computing device 400. For example, if the computing device 400 is a computer server that is part of a server system (e.g., server system 310 of FIG. 3), then the computing device 400 may not include the display mechanism 406.

The processor 402 can have generic characteristics similar to general-purpose processors, or the processor 402 may be an ASIC that provides control functions to the computing device 400. As shown in FIG. 4, the processor 402 can be coupled to all components of the computing device 400, either directly or indirectly, for communication purposes.

The memory 404 may be comprised of any suitable type of storage medium, such as SRAM, DRAM, EEPROM, flash memory, or registers. In addition to storing instructions that can be executed by the processor 402, the memory 404 can also store data generated by the processor 402 (e.g., when executing the modules of the management platform 410) or received by the communication module 408 (e.g., from the indices 420A-N, or from computing devices to which the indices 420A-N are communicatively connected). Again, the memory 404 is merely an abstract representation of a storage environment. The memory 404 could be comprised of actual chips.

The display mechanism 406 can be any mechanism that is operable to visually convey information to a user. For example, the display mechanism 406 may be a panel that includes light-emitting diodes (“LEDs”), organic LEDs, liquid crystal elements, or electrophoretic elements. In some embodiments, the display mechanism 406 is touch sensitive. Thus, the user may be able to provide input to the management platform 410 by interacting with the display mechanism 406. Alternatively, the user may be able to provide input to the management platform 410 through some other control mechanism.

The communication module 408 may be responsible for managing communications external to the computing device 400. The communication module 408 may be wireless communication circuitry that is able to establish wireless communication channels with other computing devices. Examples of wireless communication circuitry include 2.4 gigahertz (“GHz”) and 5 GHZ chipsets compatible with Institute of Electrical and Electronics Engineers (“IEEE”) 802.11—also referred to as “Wi-Fi chipsets.” Alternatively, the communication module 408 may be representative of a chipset configured for Bluetooth, NFC, and the like. Some computing devices—like mobile phones, tablet computers, and the like—are able to wirelessly communicate via separate channels. Accordingly, the communication module 408 may be one of multiple communication modules implemented in the computing device 400.

The nature, number, and type of communication channels established by the computing device 400—and more specifically, the communication module 408—can depend on (i) the sources from which data is received by the management platform 410 and (ii) the destinations to which data is transmitted by the management platform 410. Assume, for example, that the management platform 410 resides on a mobile phone in the form of a mobile application. In such embodiments, the communication module 408 can communicate with indices 420A-N external to the computing device 400 from which to obtain data. Moreover, the communication module 408 may communicate with a server system (e.g., server system 310 of FIG. 3) to which analyses of the data—or the data itself—are transmitted.

As mentioned above, data can be acquired from indices 420A-N that are external to the computing device 400. These indices 420AN could include, or be connected to, sensors or systems that are able to monitor different characteristics. For example, a given index 420A may include one or more discrete sensing units that generate values for corresponding characteristics, and these values may be provided to the management platform 410 for analysis.

For convenience, the management platform 410 may be referred to as a computer program that resides within the memory 404. However, the management platform 410 could be comprised of firmware or hardware instead of, or in addition to, software. In accordance with embodiments described herein, the management platform 410 may include a processing module 412, a tracing module 414, an analysis module 416, and a visualization module 416. These modules could be integral parts of the management platform 410, or these modules could be logically separate from the management platform 410 but operate “alongside” it. Together, these modules enable the management platform 410 to monitor produce over the course of its lifespan and convey information regarding the produce to various users.

The processing module 412 can process data obtained by the management platform 410 into a format that is suitable for the other modules. For example, the processing module 412 can apply operations to data obtained from the indices 420A-N in preparation for analysis by the other modules of the management platform 410. For example, the processing module 412 can filter or alter the data, such that the data can be more readily analyzed. As another example, the processing module 412 may parse the data in order to temporally align datasets obtained from different indices. Accordingly, the processing module 412 may be responsible for ensuring that the appropriate data is accessible to, and usable by, the other modules of the management platform 410.

The tracing module 414 may be responsible for forming, for each index, a time-synchronous record of data associated with (e.g., generated by or for) that index. At a high level, the time-synchronous record may be representative of a collection of data associated with a given index that has been processed by the processing module 412. While some data may be stored in the time-synchronous record in its “raw form,” other data may need to be more heavily processed so that insights can be gleaned through analysis. When data is stored in a time-synchronous manner, insights into location (e.g., origin) can be more easily contextualized.

The analysis module 416 may be responsible for gleaning insight through analysis of the data, either following processing by the processing module 412 or following formatting into the time-synchronous record by the tracing module 414. For example, the analysis module 416 may use machine learning algorithms to better optimize certain variables (e.g., yield, quality, etc.). As another example, the analysis module 416 may use machine learning algorithms to better understand the conditions that lead to contamination. Consider, for example, a scenario where several different batches or types of produce are determined to be contaminated. The analysis module 416 may apply a machine learning algorithm to the corresponding time-synchronous records in order to construct a model that is able to predict the likelihood of contamination upon being applied to a time-synchronous record. In a similar manner, a model could be trained using time-synchronous records associated with non-contaminated produce to better understand its conditions.

The visualization module 418 may be responsible for producing visualizations for different audiences. Farmers, for example, may be able to view heatmaps that indicate where yields are highest and what inputs were used in those areas. Transporters may be able to view reports that indicate which parameters (e.g., temperature, humidity, duration) are most important to maintaining quality. These visualizations may be based on outputs from the processing module 412, tracing module 414, or analysis module 416.

### Processing System

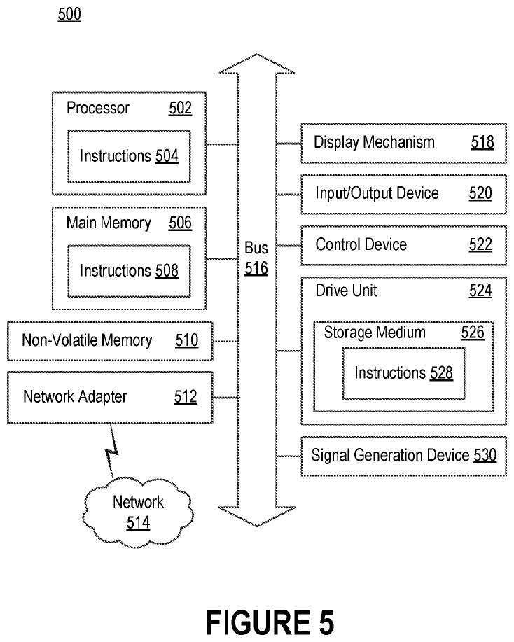

FIG. 5 is a block diagram illustrating an example of a processing system 500 in which at least some operations described herein can be implemented. For example, components of the processing system 500 can be hosted on a computing device that includes a management platform, such as computing device 104 of FIG. 1, computing device 304 of FIG. 3, or computing device 400 of FIG. 4. As another example, components of the processing system 500 can be hosted on an index, such as index 118 of FIG. 1.

The processing system 500 can include a processor 502, main memory 506, non-volatile memory 510, network adapter 512, video display 518, input/output devices 520, control device 522 (e.g., a keyboard or pointing device such as a computer mouse or trackpad), drive unit 524 including a storage medium 526, and signal generation device 530 that are communicatively connected to a bus 516. The bus 516 is illustrated as an abstraction that represents one or more physical buses or point-to-point connections that are connected by appropriate bridges, adapters, or controllers. The bus 516, therefore, can include a system bus, a Peripheral Component Interconnect (“PCI”) bus or PCI-Express bus, a HyperTransport (“HT”) bus, an Industry Standard Architecture (“ISA”) bus, a Small Computer System Interface (“SCSI”) bus, a Universal Serial Bus (“USB”) data interface, an Inter-Integrated Circuit (“I²C”) bus, or a high-performance serial bus developed in accordance with Institute of Electrical and Electronics Engineers (“IEEE”) 1394.

While the main memory 506, non-volatile memory 510, and storage medium 526 are shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the processing system 500.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in a computing device. When read and executed by the processors 502, the instruction(s) cause the processing system 500 to perform operations to execute elements involving the various aspects of the present disclosure.

Further examples of machine-and computer-readable media include recordable-type media, such as volatile memory devices and non-volatile memory devices 510, removable disks, hard disk drives, and optical disks (e.g., Compact Disk Read-Only Memory (“CD-ROMs”) and Digital Versatile Disks (“DVDs”)), and transmission-type media, such as digital and analog communication links.

The network adapter 512 enables the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments has been provided for the purposes of illustration and description. It is not intended to be exhaustive or to limit the claimed the present disclosure to the precise forms disclosed.

Many variations will be apparent to one skilled in the art. Embodiments were chosen and described in order to best describe the principles of the technology and its practical applications, thereby enabling those skilled in the relevant art to understand the present disclosure.

Although the Detailed Description describes various embodiments, the technology can be practiced in many ways no matter how detailed the Detailed Description appears. Embodiments can vary considerably in their implementation details, while still being encompassed by the present disclosure. Accordingly, the actual scope of the present disclosure encompasses not only the disclosed embodiments, but also all equivalent ways of practicing or implementing the technology.

What is claimed is:

1. A device for tracking produce through the harvesting, packing, processing, or transporting processes, the device comprising:
a structural body that roughly matches at least one physical property of the produce;
a transceiver that is configured to engage in wireless communication; and
a power component that is configured to supply power to the transceiver.

2. The device of claim 1, wherein the at least one physical property is shape, size, color, density, weight, surface texture, buoyancy, or magnetic attraction.

3. The device of claim 1, wherein the structural body does not match at least one other physical property of the produce.

4. The device of claim 1, further comprising:
a memory; and
a processor that is configured to record, in the memory, indications of data received at the transceiver from sources external to the device over at least part of a lifecycle of the produce, so as to produce an auditable log of information related to the produce.

5. The device of claim 1, further comprising:
a sensor that is configured to measure a property of the device or an ambient environment.

6. The device of claim 5, wherein the property is soil moisture, soil chemical composition, temperature, humidity, light exposure, acceleration, or orientation.

7. The device of claim 5, wherein the sensor is one of multiple sensors, each of which is configured to measure a different property of the device or the ambient environment.

8. The device of claim 1, further comprising:
a memory in which data generated by the sensor is stored.

9. The device of claim 8, further comprising:
a physical data interface via which the data is retrievable from the memory using a cable.

10. The device of claim 1, wherein the power component is a rechargeable battery.

11. The device of claim 10, further comprising:
a physical power interface via which the power component is rechargeable using a cable connected to an external power source.

12. A method for tracking produce through the harvesting, packing, processing, or transporting processes, the method comprising:
intermixing one or more indexing devices with the produce in a predetermined manner, such that each indexing device is associated with a different subset of the produce; and
causing each indexing device to be documented over an interval of time, so as to create an auditable log of conditions experienced by the different subsets of the produce.

13. The method of claim 12, wherein the different subsets correspond to different farms, different fields, or different portions of fields.

14. The method of claim 12, wherein each indexing device includes a transceiver that is able to engage in wireless communication, and wherein each indexing device is documented via presentation to a sensor that is able to detect and recognize a signal output by the transceiver.

15. The method of claim 12, wherein each indexing device includes at least one sensor that generates values for a property of that indexing device or an ambient environment and a memory in which the values are stored, and wherein the values are retrieved whenever that indexing device is documented.

16. The method of claim 12, wherein each indexing device includes at least one sensor that generates values for a property of that indexing device or an ambient environment and a memory in which the values are stored, and wherein the values are retrieved when that indexing device is removed from the corresponding subset of the produce.
